(19) United States
(12) Patent Application Publication
(10) Pub. No.: US 2008/0209453 A1
(43) Pub. Date: Aug. 28, 2008

(54) System and Method for Reducing the Start-up Time of Mhp Applications

(75) Inventor: Petrus N. Wouters, Oostelebeers (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,185

(22) PCT Filed: Sep. 28, 2005
(86) PCT No.: PCT/IB05/53199

§ 371 Date: Mar. 28, 2007

Related U.S. Application Data
(60) Provisional application No. 60/614,752, filed on Sep. 30, 2004.

(51) Int. Cl. G06F 9/445; H04N 5/00

(52) U.S. Cl. 719/332

(57) ABSTRACT

A system and method is provided for reducing the start-up time of MHP applications based on the MHP 1.0.x standard through exploiting the custom Classloader and persistent storage capabilities of MHP 1.0.x. A generic wrapper class is created that allows any MHP 1.0.x application to copy itself to, and run itself from, persistent storage thereby reducing the startup time. The generic wrapper class utilizes two pre-existing APIs in the MHP protocol, a DVBClassloader API and a persistent storage API.

The present invention relates to a system and method of reducing the start-up time of MHP applications based on the MHP 1.0.x standard

To meet the many sophisticated market-driven needs of television broadcast consumers, middleware platform providers such as those that communicate content data to subscriber set-top boxes need to access content (i.e., applications/data) that are deployed across multiple heterogeneous broadcast and Web enabled networks. These networks are generally based on a respective U.S. or European industry digital broadcast standard including, for example, Digital Video Broadcasting (DVB) (including DVB-C (cable), DVB-T (terrestrial), and DVB-S (satellite)); OpenCable™. Applications Platform (OCAP); Advanced Television Systems Committee (ATSC); National Television Standards Committee (NTSC); GI Motorola network; Multimedia Home Platform (MHP) standards and so on. The MHP standard extends the existing DVB standards for broadcast and interactive services in all transmission networks including satellite, cable, terrestrial, and microwave. The DVB/MHP standard defines a generic, i.e. hardware independent, interface between interactive digital applications and the terminals on which those applications execute. This enables digital content providers to address all, types of terminals ranging from low-end to high-end set top boxes, integrated digital TV sets and multimedia PCs.

In accordance with the DVB/MHP standard, MHP applications are broadcast in cyclic form by a protocol known as DSM-CC. In order to start an application, a receiver has to wait until at least the part that is required to start the application has come along. Very often this time equals the cycle time of the complete application which is inefficient and time-consuming. Further, bandwidth limitations and increasing application size significantly limit the application start up time even more. Storing the MHP applications in the resident file system of an integrated receiver device provides a complete solution for systems operating in accordance with the MHP 1.1.x standard in that APIs have been constructed to facilitate the retrieval of the stored MHP applications as needed. However, many users have yet to migrate from MHP 1.0.x to MHP 1.1.x and no such facility exists in the MHP 1.0.x standard for retrieving stored MHP applications.

Thus, it is desirable to provide apparatus and methods that reduce the start up time of MHP applications based on the MHP 1.0.x standard.

According to the present invention there is provided a system and method of reducing the start-up time of MHP applications based on the MHP 1.0.x standard. Broadly stated, the system and method of the invention allows MHP 1.0.x applications to reduce their start-up times by exploiting the custom Classloader and persistent storage capabilities of MHP 1.0.x as will be described.

In one embodiment, a generic wrapper (GW) class is created for MHP 1.0.x applications that allows any MHP 1.0.x application to copy itself to, and run itself from, a persistent file system, which could be associated with, for example, an interactive digital television (IDT) system or set-top box (STB), instead of the broadcast file system as is conventional to reduce the startup time of the MHP 1.0.x application. The broadcast file system is the file system as transported according to the DSM-CC protocol by the broadcast stream.

Start up time is reduced via the generic wrapper (GW) class by utilizing two pre-existing APIs in the MHP protocol, the DVBClassloader API and the persistent storage API. The DVBClassloader API is called by the generic wrapper (GW) class to instantiate a DVBClassloader object capable of loading classes and resources from directories in the resident file system. The DVBClassloader object receives a list of URLs including the location of the class files in the persistent file system and the location of the class files in the broadcast file system. The DVBClassloader object uses the first URL in the list to search for class files and resources of an MHP 1.0.x application in the persistent file system. For those classes and resources not found in the persistent file system, the DVBClassloader object uses the second URL in the list to search for those classes and resources not found in the persistent file system in the broadcast file system.

In accordance with another aspect, each time the generic wrapper (GW) class is called, a copythread process (Java task) is created that starts copying files from the broadcast system to the persistent file system. More specifically, a persistent storage API is called by the generic wrapper (GW) class. The copythread process utilizes the persistent storage API to copy as many class files of an MHP application from the broadcast stream to the persistent file system each time the generic wrapper (GW) class is called. Each time the generic wrapper (GW) class is called, the copythread process continues at the point it left off in the previous call by continuing to copy classes to the persistent storage. In this manner, the copythread process is more like a background process. As such, each call to the generic wrapper (GW) class serves to incrementally improve the start up time of the MHP application by virtue of having stored additional class files to persistent storage in each of the previous calls. In one embodiment, this process may be performed with a low priority, to be performed in parallel with the DVBClassloader API, as described above.

According to one aspect, it is possible to derive the organization ID and application ID of the MHP application before the MHP application has received the Xlet context from the resident system, by recognizing that the persistent file system directory associated with the application is the only directory it can access without security restrictions.

The foregoing features of the present invention will become more readily apparent and may be understood by referring to the following detailed description of an illustrative embodiment of the present invention, taken in conjunction with the accompanying drawings, where:

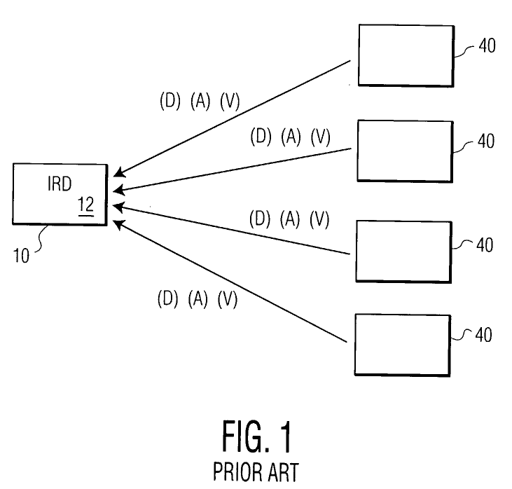

FIG. 1 illustrates the backbone of a communication system for multimedia applications;

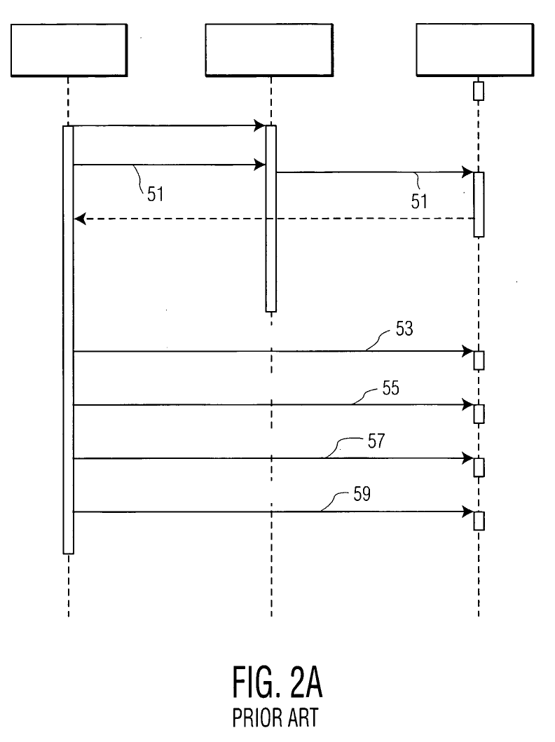

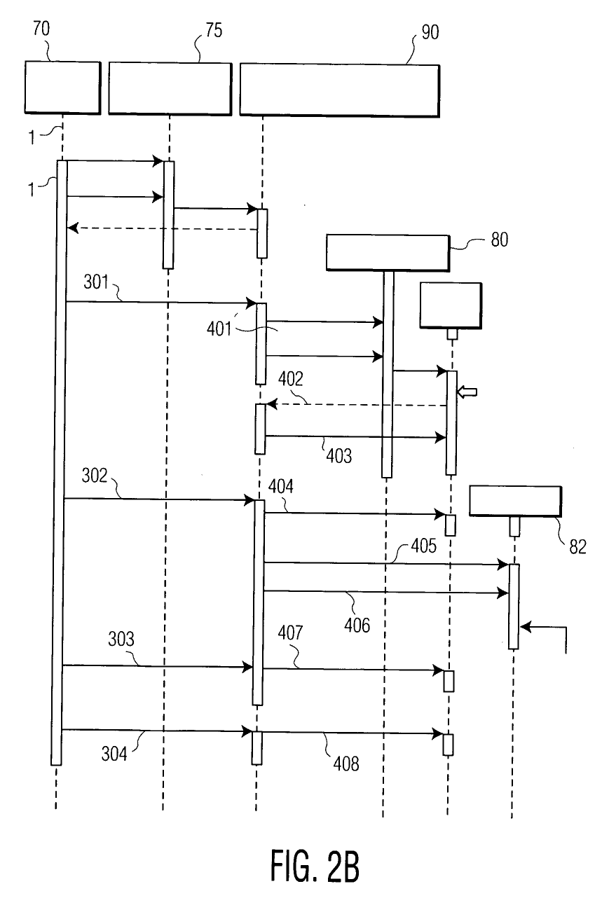

FIG. 2a illustrates a timeline diagrams illustrating XLET class loading in accordance with the prior art; and

FIG. 2b illustrates sequence diagrams illustrating XLET class loading in accordance with the invention.

The present invention will be described with reference to an embodiment for use according to the DSM-CC broadcast protocol as applied to a DVB/MHP environment.

As stated in the background, in accordance with the prior art, digital TV platforms that use DSM-CC, such as IRD receiver 12 of FIG. 1, typically cache at least some DSM-CC modules, to avoid the long delays in accessing modules encountered with systems like teletext which are caused by having to wait for the requested module's turn to be broadcast. Caching is an incomplete solution, however, because of limited memory and non-persistence. As such, storage is a preferable option. Storing MHP applications in a persistent file system for later recall is an inherent mechanism of MHP 1.1, referred to as “stored applications”, however, MHP 1.0.x provides no explicit support for such storage and recall from the persistent file system.

The system and method of the invention overcomes these drawbacks by providing a generic wrapper class that enables any existing MHP application, operating in accordance with the MHP 1.0.x specification, to copy itself to a persistent file system, and load itself from the persistent file system the next time it is started. It is noted that the copying process may not be performed in its entirety in the first or subsequent call, in which case, the next time the application is started it would only be partially loaded from the persistent file system.

The backbone of a communication system for multimedia applications will now be discussed with reference to FIG. 1. The backbone comprises a number of communication paths. The transmission medium supports high-speed transmission of digital information, such as audio (A), video (V) and data (D). A number of users are connected to the backbone, of which a first user 10 is shown in FIG. 1. This user 10 functions as a receiver of multimedia information, such as a subscriber of television programs, provided by a number of service providers, designated 40 in FIG. 1. Each user has a receiving or resident platform that could be an integrated receiver/decoder (IRD) 12 or Set-top Box (not shown) arranged to process the incoming information and sometimes also function as a transmitter of information.

In the present exemplary embodiment, the resident platform is embodied as an integrated receiver/decoder (IRD) 12 and is assumed to be DVB/MHP compliant. The Multimedia Home Platform (MHP) specification is defined by the DVB standard for the transmission of enhanced and interactive applications for digital television. The biggest feature of this specification is that it uses Java middleware. Java is middleware promoted by Sun Microsystems as a way to improve compatibility between platforms. All Java applications will run on a computer or device equipped with Java, and the greatest feature of Java applications is that they are not limited to a particular platform and can be used in a wide range of operating environments. As such, the Multimedia Home Platform (MHP) defines a generic interface between interactive digital applications and the terminals on which those applications execute. This interface de-couples different providers' applications from the specific hardware and software details of different MHP terminal implementations. It enables digital content providers to address all types of terminals ranging from low-end to high-end set top boxes, integrated digital TV sets and multimedia PCs. As used herein, an “application” is defined as a program which is executed to attain various purposes on a broadcast receiving apparatus.

MHP applications are broadcasted in a broadcast stream together with digital television programs to suitably equipped IRD receivers 12. As described in the background, the MHP applications are broadcast in a carousel format in accordance with a protocol such as the DSM-CC protocol specified under ISO/IEC1381-6, where the MHP applications are broadcast in cycles. A suitably equipped IRD receiver 12 can receive those MHP applications and run them locally. Example applications are electronic program guides, play-along games, Tele-banking, menu navigation options, Tele-shopping, electronic newspapers and similar information services.

As stated above, the invention utilizes a generic wrapper (GW) class, otherwise referred to as a PersistentCopyWrapper Xlet that allows any MHP 1.0.x application to copy itself to, and run itself from, a persistent file system. It is therefore instructive at this point to briefly review Xlets.

Sun Microsystems released a Java TV™ API, another name for which is an Xlet. Java TV applications enhance the broadcast and viewing experience by providing such features as programming information and announcements, selectable applications such as the ability to play along with a game show, broadcast data such as a stock ticker banner running across the screen, or media control such as an interactive program-related survey. Xlets, like applets, are controlled by the software that runs them. In the case of an applet, the underlying software is a browser or the appletviewer tool. In the case of an Xlet, the underlying software is the digital television receiver or set-top box that supports the Java TV platform (e.g., IRD 12 of FIG. 1). Xlets have no “main” method and Xlets always implement the interface Xlet. Like applets, Xlets have a life cycle, and the life cycle method signatures are defined by the interface Xlet. The interface Xlet provides life cycle methods to signal Xlet state changes such as, create, initialize, start, pause and destroy. However, the interface Xlet provides no implementations for its life cycle methods.

All Java TV implementations have an application manager that calls the life cycle methods to move one or more Xlets through their various application states via an interface Xlet. As stated above, the interface Xlet provides no implementations for its life cycle methods. The developer provides application-specific implementations for those methods by defining what happens at each point in the Xlet life cycle. For example, the initXlet method for a game Xlet might create the user interface components. It is noted that an Xlet can initiate some state changes itself and inform the application manager of those state changes by invoking methods on the XletContext interface.

The interface Xlet is defined by the javax.tv.xlet package which is one of the packages defined in the Java TV™ API. The Java TV™ API consists of classes and interfaces grouped into packages. These packages contain classes and interfaces to process the video, audio, and data sent to the digital receiver through the broadcast stream sent by the television networks.

The interface Xlet, defined in the javax.tv.xlet, allows an application manager to create, initialize, start, pause and destroy an Xlet. The application manager maintains the state of the Xlet and invokes methods on the Xlet via various lifecycle methods. The Xlet implements these methods to update its internal activities and resource usage as directed by the application manager.

The method summary of the interface Xlet, as defined by javax.tv.xlet is as follows. A destroyxlet signals the Xlet to terminate and enter the destroyed state. A initXlet signals the Xlet to initialize itself and enter the paused state. The pauseXlet signals the Xlet to stop providing service and enter the paused state. The startXlet signals the Xlet to start providing service and enter the active state. Certain of these methods are incorporated into a generic wrapper class of the invention, to be described below.

As is well known, MHP 1.0.x specifies an extensive application execution environment for digital interactive TV, independent of the underlying, vendor-specific, hardware and software. This execution environment is based on the use of a Java™ virtual machine and the definition of generic APIs that provide access to the interactive digital TV terminal's typical resources and facilities. A Java application using these generic APIs is called a DVB-J application. By contrast, MHP 1.1 provides additional functionality to the MHP 1.0.x platform in a number of ways including defining a new optional application type, DVB-HTML. For MHP 1.0.x, only DVB-J is required to be supported. Therefore, for a DVB-J application running under MHP 1.0.x, “javax.tv.xlet.Xlet” is the defined interface and is the only recognizable entity that can be run under MHP 1.0.x.

The present invention creates a generic Xlet wrapper class for MHP applications that allows any MHP 1.0.x application to store code (class files) of an MHP application to a persistent file system and use the stored class files to load the complete MHP application from the persistent file system the next time it is run. In this manner, MHP applications, which are normally not stored, realize improved start up time.

The invention is preferably implemented in a generic way by creating a generic wrapper (GW) Xlet class to be described, otherwise referred to herein as “PersistentXletCopyWrapperXlet”, for MHP applications that allow any MHP 1.0.x application to copy itself to and run itself from the persistent file system.

The generic wrapper (GW) class is designed in such a way that each method, constructor, static initializer called in the GW wrapper class will be propagated to a corresponding method, constructor, static initializer in the original MHP 1.0.x application. In fact, the interface is exactly the same as the MHP 1.0.x application interface that it wraps around.

In addition to mirroring the functionality of the original MHP 1.0.x application, the generic wrapper class includes two API's. One API is the DVBClassloader API which is an extension of the Java classloader and is part of the MHP API. It's a special extension in that it's the only classloader available for use by MHP applications. The DVBClassloader API is used to load classes and resources from a search path of URLs referring to locations where Java classes may be stored. As used in the present invention, the DVBClassloader API is provided with a search path of URLs corresponding to a list of locations in the persistent file system and a search path of URLs corresponding to a list of locations in the broadcast file system where it can look for classes of the MHP application.

The second API is a persistent storage API which can work substantially in parallel with the DVBClassloader API whenever the “PersistentXletCopyWrapperXlet” class is called. A Copythread process copies the class files of the MHP 1.0.x application from the broadcast stream to the persistent file system. Each time the “PersistentXletCopyWrapperXlet” class is called, the Copythread process continues at the point it left off in the previous call by continuing to copy classes to the persistent file system. In this manner, the Copythread process is more like a background process. As such, each call to the “PersistentXletCopyWrapperXlet” class only serves to improve the start up time of the MHP 1.0.x application by virtue of having stored additional class files to the persistent file system in each of the previous calls.

FIG. 2a and FIG. 2b illustrate sequence diagrams illustrating the mechanics of a call to an MHP application in accordance with the prior art (FIG. 2a) and a call to the “PersistentXletCopyWrapperXlet” class of the invention (FIG. 2b). Chronologically, the sequence diagrams begin at a point after which a user has zapped to a channel and the MHP system responsively determines (1) that there may be MHP applications associated with that channel and (2) which Xlet class files belong to each MHP application, and (3) the location of the stream and the class. All of this is encapsulated into the MHP protocol. At some point the system will start loading the class files, which is where FIGS. 2a and 2b begin.

FIG. 2a is a sequence diagram of the prior art. It illustrates that when an MHP application is started the MHP system will execute the following steps: (I) load the Xlet class, see label 51 (i.e. the Java class implementing the Xlet interface, AnXlet), (2) execute the static initializers of the Xlet class, see label 53, (3) create an instance of the Xlet class and execute its default constructors, see label 55, (4) call init Xlet, see label 57, (5) call start Xlet, see label 59. These steps control the lifecycle of the MHP application. It is noted that each time an MHP application is started, the same steps are performed. Larger applications necessarily take a longer time to load than smaller applications. In some instances, the classes shown will recursively load other classes having their own constructor and initializers requiring additional time.

FIG. 2b is a sequence diagram in accordance with an embodiment of the invention illustrating the steps performed by the generic wrapper class, “PersistentXletCopyWrapperXlet”, referred to hereafter as the GW class 90. The GW class 90 in addition to performing the acts of the prior art (as shown in FIG. 2a) for starting an MHP application, additionally calls two API's. A DVBClassloader API and a persistent file system API.

The MHP system 70 implicitly instantiates a classloader 75 to load the xlet classes. (This classloader is system-specific and can therefore not be used by the application.)

The MHP system 70 then calls “loadClass” 201 to load the GW class 90.

The MHP system 70 then calls “static initializer” 301 of the GW class 90. This call in turn instantiates a DVBClassloader object 80. As stated above, the DVBClassloader is the only kind of classloader that an MHP application can utilize in an MHP 1.0.x system to load a MHP application from the persistent file storage system. The DVBClassloader is a system resource and receives a list of URL parameters (not shown). In the preferred embodiment, the DVBClassloader object 80 receives two URLs that define or point to the location(s) of the class files and resources in the persistent file system and in the broadcast file system.

The DVBClassloader object 80 uses the first provided URL to search for class files and resources of an MHP application in the persistent file system. Not all classes and resources may be found in the persistent file system. For those classes and resources not found in the persistent file system, the DVBClassloader object 80 then uses the second provided URL to search for classes and resources in the broadcast file system. It should be appreciated that the order is very important, as this represents a key feature of the invention, because class files should always be loaded from the persistent file system if present (i.e., that is assuming that they were already copied there from a previous call) and only loaded from the broadcast system in lieu of not finding them in the persistent file system.

Retrieving the class files in the precise order described above (i.e., searching the persistent file system followed by searching the broadcast system) allows for incremental improvement in the start up time of an MHP application over successive calls to the MHP application. This occurs because at each call, the background copythread process copies additional classes and resources from the broadcast file system to the persistent file system. This is in contrast to performing a copy operation at the first call in which all of the classes are copied, and only then loading them from the persistent file system.

Typically, the DVBClassloader object 80 will be created by the DVBClassloader as follows:

| | |
|---|---|
| Line 1 | String root=System.getProperty(“dvb.persistentroot”); |
| Line 2 | persistentUrl = new URL(“file:/”+root+“/”+orgid |
| | +“/”+appid); |
| Line 3 | broadcastUrl = new URL(“file://”); |
| Line 4 | URL[ ] urls = new URL[ ] { persistentUrl, broadcastUrl }; |
| Line 5 | DVBClassloader 1 = DVBClassloader.newInstance(urls); |

Note that on line 4, the preferred order of searching URL's, described above, is defined. That is, a first or initial search is made in the persistent file system, i.e., persistentUrl, and then, if necessary, a second search is made in the broadcast file system, broadcastUrl, for whatever class files and resources were not found in the persistent file storage system during the initial search.

The GW class 90, next calls loadClass of the DVBClassloader object 80 to load the original Xlet class. At this point, the preferred search order is invoked, namely, persistent file system followed by broadcast file system, to retrieve the Xlet classes and resources from one or the other location.

The call to the DVBClassloader object 80, returns a class called AnXlet 402, which is the Xlet class from the MHP application being executed.

The GW class 90, next calls the static initializer 403 of the original Xlet class.

Static Initialization of the Xlet class is complete and the MHP system 70 can instantiate 302 the generic wrapper (GW) class 90 which in turn instantiates 404 the MHP application

The GW class 90 then creates a thread 405 that will execute the copying process

The GW class 90 then starts the thread 406 that will recursively copy files and directories from the broadcast stream to the persistent file system

The MHP system 70 then calls initXlet 303 of the GW class 90, initXlet 801 which will in turn call initXlet 407 of the MHP 1.0.x application

The MHP system 70 then calls startXlet 304 of the GW class 90, which will in turn call startXlet 408 of the MHP 1.0.x application

According to another aspect, it is possible to derive the organization ID and application ID of an MHP application before the MHP application has received the Xlet context from the system. That is, at a point in time prior to calling initXlet (see 303 of FIG. 2b). As will be described in greater detail below, derivation of the organization ID and application ID is accomplished by recognizing that the persistent file-system directory associated with the application is the only directory it can access without security restrictions. Each MHP application that is broadcast is given a unique identifier, which is also stored in an extra service information (SI) table called the application information table (AIT). The AIT is broadcast for every service that contains an MHP application, and it contains an entry for every MHP application that's valid for that service. Thus, if a service has two applications associated with it, this table will contain two entries. The unique identifier given to each MHP application allows other parts of the system to be able to refer to an application uniquely, since the name or other attributes may not be unique. Each identifier consists of two parts—a 32 bit organization ID, which is unique to every organization that produces MHP applications, and a 16 bit application ID. This application ID does not have to be unique, but no two applications signaled in the same AIT can have the same organization ID and application ID.

The key to being able to derive the organization ID and application ID of an MHP application before the MHP application has received the Xlet context from the system is knowing that an Xlet has only access to its own application directory. This information is used in the following way.

By means of the application lifecycle API, the generic wrapper (GW) class, (i.e., “PersistentXletCopyWrapperXlet”), receives a list containing all currently known applications. Once this list is obtained, the GW class tries to access the application directory associated with each application on the list. In all cases, except one, a “Security Exception” will occur. Only the application's own directory will not throw a “Security Exception” because, as stated above, an Xlet only has access to its own application directory. Because the application lifecycle API exposes the organization ID and the application ID of all known applications, the corresponding can be derived.

In sum, the system and method of the invention overcomes the lack of explicit support for persistently stored applications in MHP 1.0.x. Persistent storage being defined as those applications that can be broadcast such that they are persistently stored on the MHP implementation and available for later execution without downloading them again from the broadcast stream. More specifically, the system and method of the invention advantageously allows any MHP 1.0.x application to copy itself and run itself from persistent storage by creating a generic wrapper class that allows any MHP 1.0.x application to copy itself and run itself from persistent storage.

In addition, the system and method of the invention also provides a way to derive the organization ID and application ID of an MHP application before the MHP application has received the Xlet context from the system.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

What is claimed is:

1. A method for reducing the start-up time of an MHP 1.0.x application, the method comprising the acts of:
creating a generic wrapper (GW) class;
responsive to each call of the GW class, performing the acts of:
(a) loading a portion of classes and resources of said MHP 1.0.x application from a persistent file system where said portion of classes and resources are stored; and
(b) loading a remaining portion of said classes and resources of said MHP 1.0.x application from a broadcast file system.

2. The method of claim 1, further comprising the act of copying at least a portion of said remaining portion of classes and resources of said MHP 1.0.x application from said broadcast file system to said persistent file system.

3. The method of claim 2, wherein the act of copying is performed under control of a Copythread process.

4. The method of claim 3, wherein the Copythread process utilizes a persistent storage API as defined in the MHP protocol.

5. The method of claim 1, wherein the act of loading at steps (a) and (b) utilize a DVBClassloader API as defined in the MHP protocol.

6. The method of claim 5, wherein said DVBCLassloader API includes at least a first URL parameter and a second URL parameter, wherein the first URL parameter defines a class path to a location in said persistent storage wherein said portion of classes and resources of said MHP 1.0.x application are stored and wherein the second URL parameter defines a class path to a location in said broadcast file system said MHP 1.0.x application wherein said remaining portion of said classes and resources of said MHP 1.0.x application are stored.

7. A method for reducing the start-up time of MHP applications based on the MHP 1.0.x standard, the method comprising the acts of:
(a) creating a generic wrapper (GW) class for an MHP application;
(b) calling from the generic wrapper (GW) class, a first API having a first parameter identifying to a first URL search path corresponding to a location in the persistent file system of a receiver device where classes and resources of the MHP application are stored, said first API further having a second parameter identifying a second URL search path corresponding to a location in a broadcast file system where classes and resources of the MHP application are stored;
(c) loading, under control of said first API, classes and resources associated with said MHP application presently stored in said persistent file system;
(d) loading, under control of said first API, any remaining classes and resources associated with said MHP application from said broadcast file system which were not presently stored in said persistent file system, utilizing said second parameter.

8. The method of claim 7, wherein the first API is a DVBCLassloader API.

9. The method of claim 7, further comprising the acts of:
(a) calling a second API from said generic wrapper (GW) class; and
(b) starting a thread from said called second API that recursively copies files and directories associated with said MHP application from the broadcast stream to said persistent file system.

10. The method of claim 3, wherein said first and second APIs operate substantially in parallel.

11. The method of claim 4, wherein the second API is a persistent storage API.

12. An integrated receiver device operating in accordance with the MHP 1.0.x standard, said receiver comprising:
means for creating a generic wrapper class for an MHP application;
means for loading a portion of said MHP 1.0.x application currently residing in a persistent file system; and
means for copying at least a portion of said MHP 1.0.x application not currently residing in the persistent file system.

13. The method of claim 12, wherein the means for copying further comprises copying class files and resources of said MHP 1.0.x application from a broadcast stream broadcasting said MHP 1.0.x application to said persistent file system.

14. The method of claim 12, wherein the means for copying is performed under control of a Copythread process.

15. The method of claim 14, wherein the Copythread process utilizes a persistent storage API as defined in the MHP protocol.

16. The method of claim 12, wherein the means for loading utilizes a DVBClassloader API as defined in the MHP protocol.

17. The method of claim 16, wherein said DVBCLassloader API includes at least a first and a second URL parameter defining a class path to a location in said persistent file system wherein class files of said MHP application are stored and wherein the second URL parameter defines a class path to a location in a file system of a broadcast file system of a broadcast stream broadcasting said MHP 1.0.x application

18. A method for providing a way to derive the organization ID and application ID of an MHP application before the MHP application has received an Xlet context from an MHP system, comprising the acts of:
receiving, by a generic wrapper (GW) class, a list of all currently known applications from said MHP system, each application on said list including an associated organization ID and an application ID;
converting each application on said list to a directory listing identifying the application in a persistent file system using said organization ID and said application ID;
attempting to access each of the directory listings, by said GW class;
determining which application from among said list does not return a security exception;
deriving the organization ID and application ID from the determining step as the application that does not return the security exception.

19. The method of claim 18 wherein the conversion act further comprises constructing said directory listing using said organization ID and said application ID in the form: persistent root/organization ID/application ID.
